(19) United States
(12) Patent Application Publication
(10) Pub. No.: US 2024/0034929 A1
(43) Pub. Date: Feb. 1, 2024

(54) SCINTILLATION MATERIALS AND METHODS

(71) Applicant: Florida State University Research Foundation, Inc., Tallahassee, FL (US)

(72) Inventors: Biwu MA, Tallahassee, FL (US); Tunde B. SHONDE, Tallahassee, FL (US); Maya CHAABAN, Tallahassee, FL (US)

(21) Appl. No.: 18/355,908

(22) Filed: Jul. 20, 2023

Related U.S. Application Data
(60) Provisional application No. 63/390,793, filed on Jul. 20, 2022.

(51) Int. Cl. C09K 11/54; C09K 11/06

(52) U.S. Cl. CPC C09K 11/54; C09K 11/06

(57) ABSTRACT

Organic metal halide hybrid-based scintillation materials are provided, as well as methods of fabricating and using the same. The scintillation materials can be zero-dimensional (0D) organic metal halide hybrid-based scintillation materials, such as 4-(4-(diphenylamino) phenyl)-1-(Propyl)-pyrindin-lium zinc bromide ((TPA-P)₂ZnBr₄), in which at least one metal halide anion (e.g., ZnBr₄²⁻) act(s) as an X-ray sensitizer and at least one aggregate induced emission (AIE) organic cation (e.g., TPA-P⁺) act(s) as a light emitter.

### CROSS-REFERENCE TO RELATED APPLICATION

This application claims the benefit of U.S. Provisional Application Ser. No. 63/390,793, filed Jul. 20, 2022, the disclosure of which is hereby incorporated by reference in its entirety, including all figures, tables, and drawings.

### BACKGROUND

Scintillation materials are widely used in X-ray and gamma-ray detectors for various applications, ranging from security inspection to radiation exposure monitoring, medical diagnosis, and treatment, as well as high-energy physics and fundamental scientific studies.

Upon interaction with incident radiation, a scintillation material absorbs part of the energy of the incident particle and re-emits the absorbed energy in the form of light, usually in the visible spectral range, which can be coupled to a photomultiplier tube or a photodiode for conversion to electrical signals for further processing. In addition to confirming the presence and measuring the dose of the incident radiation, spectroscopic studies can also be performed to characterize the energy of the incident radiation, which could be used to identify the types of radiation sources.

Most existing high-performance (high light yield and good energy resolution) scintillators are inorganic crystals, which are somewhat expensive due to time-consuming high-temperature synthesis and the use of rare-earth materials. Other disadvantages of inorganic scintillation materials include high hygroscopicity, slow scintillation with long decay lifetimes, and limited crystal sizes. Organic and plastic scintillators, on the other hand, can be produced at low costs and exhibit fast responses with short radioluminescence decay lifetimes. However, most carbon-based organic/plastic scintillators suffer from low light yield and poor energy resolution due to weak X-ray attenuation, as a result of low atomic numbers (Z) of their constituent elements and inefficient utilization of triplet excitons.

### BRIEF SUMMARY

Embodiments of the subject invention provide novel and advantageous metal halide hybrid-based scintillation materials and methods of fabricating and using the same. Metal halide hybrid-based scintillation materials can include zero-dimensional (0D) organic metal halide hybrid-based scintillation materials, such as 4-(4-(diphenylamino) phenyl)-1-(Propyl)-pyrindin-lium zinc bromide ((TPA-P)₂ZnBr₄), in which at least one metal halide anion (e.g., ZnBr₄²⁻) act(s) as an X-ray sensitizer and at least one aggregate induced emission (AIE) organic cation (e.g., TPA-P⁺) act(s) as a light emitter.

In an embodiment, a scintillation material can comprise an organic-inorganic hybrid material comprising a metal halide anion and an organic cation. The scintillation material can have: a light yield of at least 15,000 photons per mega electron Volt (photons/MeV); a decay lifetime in a range of from 1 nanosecond (ns) to 100 ns (e.g., from 2 ns to 5 ns, or from 3 ns to 4 ns); a light yield to decay time ratio of at least 1,000 photons/MeV-ns; and/or a detection limit of no more than 25 nanoGrays per second (nGyₐᵢᵣ/s). The organic-inorganic hybrid material can be a 0D material. The metal halide anion can be an X-ray sensitizer, and the organic cation can be a light emitter. The organic cation can be an AIE organic cation, such as TPA-P⁺. The metal halide anion can be, for example, ZnX₄, where X is a halogen (e.g., Br). The organic-inorganic hybrid material can be, for example, 4-(4-(diphenylamino) phenyl)-1-(Propyl)-pyrindin-lium zinc halide ((TPA-P)₂ZnX₄) (e.g., (TPA-P)₂ZnBr₄).

In another embodiment, a detector for X-rays and/or gamma rays can comprise a scintillation material as described herein.

In another embodiment, a method of fabricating a scintillation material can comprise: contacting (i) a triaryl amine substituted with a first electron withdrawing group, and (ii) a pyridine substituted with a second electron withdrawing group, to form an intermediate product; and contacting the intermediate product and an alkyl halide to form an organic halide salt. The method can further comprise: providing a precursor liquid in which the organic halide salt and a metal halide salt are disposed; and contacting the precursor liquid with an antisolvent to form an organic-inorganic hybrid material that is the scintillation material. The first electron withdrawing group can be a halide. The triaryl amine can be, for example, a triphenyl amine. The triaryl amine substituted with a first electron withdrawing group can be the compound of formula (I) herein. The pyridine substituted with a second electron withdrawing group can be the compound of formula (II) herein. The first electron withdrawing group and the second electron withdrawing group can be different from each other. The second electron withdrawing group can be —B(OH)₂. The alkyl halide can be an alkyl bromide. The alkyl halide can be a C2-C5 alkyl halide. The alkyl halide can be propyl bromide (e.g., n-propyl-1-bromide). The organic halide salt can be, for example, TBA-PBr. The antisolvent can be, for example, diethyl ether. The metal halide salt can be a zinc halide salt (e.g., ZnBr₂). A mole ratio of the organic halide salt to the metal halide salt can be in a range of, for example, from 0.5:1 to 3.5:1 (e.g., from 1:1 to 3:1). The organic-inorganic hybrid material can be a 0D material. The organic-inorganic hybrid material can be TPA-P)₂ZnX₄) (e.g., (TPA-P)₂ZnBr₄). The organic-inorganic hybrid material can have: a light yield of at least 15,000 photons/MeV; a decay lifetime in a range of from 1 ns to 100 ns (e.g., from 2 ns to 5 ns, or from 3 ns to 4 ns); a light yield to decay time ratio of at least 1,500 photons/MeV-ns; and/or a detection limit of no more than 25 nGyₐᵢᵣ/s.

### BRIEF DESCRIPTION OF DRAWINGS

FIG. 1a shows a schematic of X-ray scintillation processes for organic metal halide hybrids with metal halides as sensitizer and organic cations as emitter, according to an embodiment of the subject invention.

FIG. 1b shows a design of zero-dimensional (0D) organic metal halide hybrid containing metal halide polyhedrons (ZnBr₄²⁻, squares) fully isolated and surrounded by aggregate induced emission (AIE) organic cations (TPA-P⁺), and mechanism of sensitized radioluminescence, according to an embodiment of the subject invention.

FIG. 2a shows a synthetic scheme for the preparation of TPA-PBr.

FIG. 2b shows a view of antisolvent diffusion growth of (TPA-P)₂ZnBr₄ single crystals.

FIG. 2c shows an image of TPA-PBr under ambient light.

FIG. 2d shows an image of (TPA-P)₂ZnBr₄ single crystals under ambient light.

FIG. 2e shows a view of the crystal structure of TPA-PBr. The hydrogen atoms are hidden for clarity.

FIG. 2f shows a view of the crystal structure of (TPA-P)₂ZnBr₄. The hydrogen atoms are hidden for clarity.

FIG. 3a shows a plot of intensity (in arbitrary units (a.u.)) versus wavelength (in nanometers (nm)), showing emission and excitation spectra of anthracene, TPA-PBr, and (TPA-P)2ZnBr4. The inset shows images of (left to right) anthracene, TPA-PBr, and (TPA-P)2ZnBr4 samples under ultraviolet (UV) light (365 nm).

FIG. 3b shows a plot of intensity (in a.u.) versus wavelength (in nm)), showing absorption spectra of anthracene, TPA-PBr, and (TPA-P)2ZnBr4. The curve with the highest intensity at a wavelength of 525 nm is for (TPA-P)2ZnBr4; the curve with the second-highest intensity at a wavelength of 525 nm is for TPA-PBr; and the curve with the lowest intensity at a wavelength of 525 nm is for anthracene.

FIG. 3c shows a plot of intensity (in counts) versus time (in nanoseconds (ns)), showing time-resolved photoluminescence of anthracene, TPA-PBr, and (TPA-P)2ZnBr4 in solid state.

FIG. 3d shows a bar chart of photoluminescence quantum yield (PLQY) (in percentage (%)) for anthracene, TPA-PBr, and (TPA-P)2ZnBr4.

FIG. 4a shows a plot of mass absorption coefficient (in square centimeters per gram (cm²/g)) versus photon energy (in mega electron Volts (MeV)), showing Theoretical mass absorption coefficient of anthracene, TPA-PBr, and (TPA-P)2ZnBr4. The curve with the highest mass absorption coefficient values is for TPA-P)2ZnBr4; the curve with the second-highest mass absorption coefficient values is for TPA-PBr; and the curve with the lowest mass absorption coefficient values is for anthracene.

FIG. 4b shows a plot of theoretical effective Z versus photon energy (in MeV) of anthracene, TPA-PBr and (TPA-P)2ZnBr4. The curve with the highest effective Z values is for TPA-P)2ZnBr4; the curve with the second-highest effective Z values is for TPA-PBr; and the curve with the lowest effective Z values is for anthracene.

FIG. 4c shows a plot of normalized radioluminescence intensity (in a.u.) versus wavelength (in nm), showing radioluminescence spectra of anthracene, TPA-PBr, and (TPA-P)2ZnBr4 in the solid state under an X-ray dose rate of 221.39 micro-Grays per second (μGyₐᵢᵣ/s) excitation. The inset shows images of (from left to right) anthracene, TPA-PBr, and (TPA-P)2ZnBr4 under X-ray excitation. The curve with the highest normalized radioluminescence intensity at a wavelength of 426 nm is for anthracene; the curve with the highest normalized radioluminescence intensity at a wavelength of 546 nm is for TPA-PBr; and the curve with the highest normalized radioluminescence intensity at a wavelength of 546 nm is for (TPA-P)2ZnBr4.

FIG. 4d shows a bar chart of integrated radioluminescence intensity (in count per second (cps)×10⁸) versus mass concentration (for 20 milligrams per milliliter (mg/ml), 30 mg/ml, and 50 mg/ml), showing integrated radioluminescence intensities of different mass concentrations of anthracene, TPA-PBr, and (TPA-P)2ZnBr4 in polydimethylsiloxane (PDMS) composites under an X-ray dose rate 221.39 μGyₐᵢᵣ/s excitation. At each mass concentration, the left-most bar is for anthracene, the middle bar is for TPA-PBr, and the right-most bar is for (TPA-P)2ZnBr4.

FIG. 4e shows a plot of radioluminescence intensity (in cps×10⁸) for (TPA-P)2ZnBr4 with a standard reference of lutetium aluminum garnet (LuAG) activated by cerium (Ce) (LuAG:Ce) under an X-ray dose rate of 221.39 μGyₐᵢᵣ/s.

FIG. 4f shows a plot of radioluminescence intensity (in cps×10⁷) versus dose rage (in Gyₐᵢᵣ/s) for (TPA-P)2ZnBr4 and LuAG:Ce, showing dose rate dependence of the radioluminescence intensities of these materials. The curve with the higher radioluminescence intensity values is for (TPA-P)2ZnBr4, and the curve with the lower radioluminescence intensity values is for LuAG:Ce.

FIG. 5a shows a bar chart of the values of a figure of merit (FoM) of light yield versus decay time for (TPA-P)2ZnBr4, as well as several commercially available scintillators.

FIG. 5b shows a plot of radioluminescence intensity (in cps×10⁵) versus wavelength (in nm), showing radioluminescence intensity under an X-ray dose rate of 221.39 μGyₐᵢᵣ/s of (TPA-P)2ZnBr4 samples after heating at 100° C. for different amounts of time.

FIG. 5c shows a schematic illustration of a lab-built X-ray imaging system.

FIG. 5d shows images of 6.0 wt % (TPA-P)2ZnBr4 in PDMS under ambient (top) and under UV light at 365 nm (bottom).

FIG. 5e shows an image of an encapsulated metallic spring.

FIG. 5f (directly under FIG. 5e) shows an X-ray image of the encapsulated metallic spring of FIG. 5e. The scale bar is 5 millimeters (mm).

FIG. 6 shows a table of health toxicity classification of metal halides and oxides acquired from a material safety data sheet (MSDS). An acute toxicity category 1 refers to the most severe toxicity with an oral lethal dose 50 (LD50) of less than 5 milligrams per kilograms (mg/kg). Category 2 refers to 5 mg/kg<LD50<50 mg/kg, category 3 refers to 50 mg/kg<LD50<300 mg/kg, and Category 4 refers to 300 mg/kg<LD50<2000 mg/kg. Metal halides and oxides were used for comparison because the toxicity data for commercial scintillators is unavailable.

FIG. 7 shows a table of single crystal X-ray diffraction data of TPA-PBr and (TPA-P)2ZnBr4.

FIG. 8 shows a table of selected bond distance and angles of (TPA-P)2ZnBr4.

FIG. 9 shows a table of Fitting parameters for photoluminescence decay kinetics of Anthracene, TPA-PBr, and (TPA-P)2ZnBr4.

FIG. 10 shows a table of the relationship between voltage, current, and corresponding dose rate X-ray used for experiments.

FIG. 11 shows a synthetic scheme for the preparation of 4-(4-(diphenylamino) phenyl)-1-(Propyl)-pyrindin-lium bromide (TPA-PBr).

FIG. 12 shows a synthesis scheme for the preparation of 0D 4-(4-(diphenylamino) phenyl)-1-(Propyl)-pyrindin-lium zinc bromide ((TPA-P)2ZnBr4).

FIG. 13 shows nuclear magnetic resonance (NMR) characterization of TPA-PY, in particular ¹H NMR of TPA-PY.

FIG. 14 shows NMR characterization of TPA-PBr, in particular ¹H NMR of TPA-PBr.

FIG. 15 shows a high-resolution mass spectroscopy (HRMS) spectrum of TPA-PY.

FIG. 16 shows an HRMS spectrum of TPA-PBr.

FIG. 17a shows a view of single crystal X-ray diffraction (SCXRD) of TPA-PBr.

FIG. 17b shows a view of SCXRD of (TPA-P)2ZnBr4.

FIG. 18 shows powder X-ray diffraction (PXRD) patterns of (TPA-P)2ZnBr4. The curve that is higher in the figure is for simulated results, and the curve that is lower in the figure is for experimental results.

FIG. 19 shows a plot of weight (in %) versus temperature (in ° C.), showing thermal stability of TPA-PBr and (TPA-P)2ZnBr4 via a thermogravimetric analysis. The curve with the higher weight value at a temperature of 300° C. is for (TPA-P)2ZnBr4, and the curve with the lower weight value at a temperature of 300° C. is for TPA-PBr.

FIG. 20 shows an image of samples of an AIE properties study of TPA-PBr under daylight (top row) and 365 nm UV light (bottom row). TPA-PBr was dissolved in a polar and polar/nonpolar mixture. Dimethylsulfoxide (DMSO) was the polar solvent while toluene was the nonpolar solvent. From left to right, the images show: 100% DMSO 0% toluene; 90% DMSO 10% toluene; 80% DMSO, 20% toluene; 70% DMSO, 30% toluene; 60% DMSO, 40% toluene; 50% DMSO, 50% toluene; 40% DMSO, 60% toluene; 30% DMSO, 70% toluene; 20% DMSO, 80% toluene; and 10% DMSO, 90% toluene.

FIG. 21a shows a plot of linear attenuation coefficient (in per centimeter (cm⁻¹)) versus photon energy (in kilo electron Volts (keV)), computed using NIST software. The curve with the highest linear attenuation coefficient at a photon energy of 60 keV is for (TPA-P)2ZnBr4; the curve with the second-highest linear attenuation coefficient at a photon energy of 60 keV is for TPA-PBr; and the curve with the lowest linear attenuation coefficient at a photon energy of 60 keV is for anthracene.

FIG. 21b shows a plot of X-ray attenuation efficiency (in %) versus X-ray energy (in keV) for a 0.04 centimeter (cm) thick scintillator. The curve with the highest X-ray attenuation efficiency at a photon energy of 30 keV is for (TPA-P)2ZnBr4; the curve with the second-highest X-ray attenuation efficiency at a photon energy of 30 keV is for TPA-PBr; and the curve with the lowest X-ray attenuation efficiency at a photon energy of 30 keV is for anthracene.

FIG. 22a shows a plot of thickness (in cm) versus X-ray attenuation efficiency (in %), showing the thickness required to attenuate 10.3 keV of X-ray energy. The curve with the highest thickness at an X-ray attenuation efficiency of 80% is for anthracene; the curve with the second-highest thickness at an X-ray attenuation efficiency of 80% is for TPA-PBr; and the curve with the lowest thickness at an X-ray attenuation efficiency of 80% is for (TPA-P)2ZnBr4.

FIG. 22b shows a plot of thickness (in cm) versus X-ray attenuation efficiency (in %), showing the thickness required to attenuate 51.0 keV of X-ray energy. The curve with the highest thickness at an X-ray attenuation efficiency of 80% is for anthracene; the curve with the second-highest thickness at an X-ray attenuation efficiency of 80% is for TPA-PBr; and the curve with the lowest thickness at an X-ray attenuation efficiency of 80% is for (TPA-P)2ZnBr4.

FIG. 23a shows a plot of intensity (in a.u.) versus wavelength (in nm), showing photoluminescence spectra of (TPA-P)2ZnBr4 and LuAG:Ce under 365 nm UV excitation. The curve with its peak around 500 nm is for LuAG:Ce; and the curve with its peak around 550 nm is for (TPA-P)2ZnBr4.

FIG. 23b shows a plot of intensity (in a.u.) versus wavelength (in nm), showing radioluminescence spectra of (TPA-P)2ZnBr4 and LuAG:Ce under X-ray excitation of 221.39 μGyₐᵢᵣ/s. The curve with its peak around 500 nm is for LuAG:Ce; and the curve with its peak around 550 nm is for (TPA-P)2ZnBr4.

FIG. 24a shows a plot of intensity (in cps×10⁵) versus wavelength (in nm), showing radioluminescence spectra of (TPA-P)₂ZnBr₄ under X-ray excitation dose rates ranging from 3.08 μGyₐᵢᵣ/s to 221.39 μGyₐᵢᵣ/s.

FIG. 24b shows a plot of intensity (in cps×10⁵) versus wavelength (in nm), showing radioluminescence spectra of LuAG:Ce under X-ray excitation dose rates ranging from 3.08 μGyₐᵢᵣ/s to 221.39 μGyₐᵢᵣ/s.

### DETAILED DESCRIPTION

Embodiments of the subject invention provide novel and advantageous metal halide hybrid-based scintillation materials and methods of fabricating and using the same. Metal halide hybrid-based scintillation materials can include zero-dimensional (0D) organic metal halide hybrid-based scintillation materials, such as 4-(4-(diphenylamino) phenyl)-1-(Propyl)-pyrindin-lium zinc bromide ((TPA-P)₂ZnBr₄), in which at least one metal halide anion (e.g., ZnBr₄²⁻) act(s) as an X-ray sensitizer and at least one aggregate induced emission (AIE) organic cation (e.g., TPA-P⁺) act(s) as a light emitter. Materials of embodiments of the subject invention can achieve a light yield of, for example, at least 15,000 photons per mega electron Volt (MeV) (photons/MeV) (e.g., 16,000 photons/MeV or higher), which is higher than that of anthracene (about 13,500 photons/MeV). Materials of embodiments of the subject invention can have a decay lifetime (e.g., 9.96 nanoseconds (ns), about 9.96 ns, or in a range of from 1 ns to 100 ns) similar to those of pure organic scintillators. Materials of embodiments can have a light yield to decay time ratio of at least 1,000 photons/MeV-ns (e.g., 1,500 photons/MeV-ns or about 1,500 photons/MeV-ns) and/or a detection limit of no more than 25 nanoGrays per second (nGyₐᵢᵣ/s) (e.g., 21.3 nGyₐᵢᵣ/s or about 21.3 nGyₐᵢᵣ/s), both of which are among the best values achieved for any type of scintillation material.

In order to address the issue of low light yield of pure organic scintillators discussed in the Background, a variety of complex and hybrid materials with enhanced X-ray absorption and triplet excitons utilization have been developed in recent years. Introducing heavy atom halogens (such as bromine (Br) and iodine (I)) and complexing with heavy atoms (such as iridium (Ir) and platinum (Pt)) are two approaches to simultaneously improving X-ray absorption coefficient and facilitating intersystem crossing (ISC) to achieve phosphorescence.

Thermally activated delayed fluorescence (TADF) materials have also been used as scintillators with high light yields due to their capability of circumventing the common triplet exciton loss channels. While these phosphorescent and TADF materials show improved light yields, the long radio-luminescent decay lifetimes in the order of milliseconds present a major drawback. In order to improve the X-ray absorption while maintaining the short decay lifetimes of organic scintillators, sensitization using various types of high-Z materials, including organometallics, oxide nanoparticles, and metal halides, can be an effective approach.

However, a hybrid sensitized system with mixing of complementary elements may suffer from inferior exciton harvesting due to low uniformity and insufficient charge/energy transfer. Chemically bonding high Z radiation sensitizers and organic light emitters in a single crystalline system represents a promising strategy for the development of new generation scintillation materials. Metal-organic frameworks (MOFs) represent one such single-crystalline hybrid system, in which scintillating fluorescent dyes are interconnected by clusters containing high Z elements. However, like typical organic scintillators, existing MOFs exhibit concentration quenching due to aggregation, thus limiting their bulk usage.

Organic metal halide hybrids, in which organic and metal halide ions co-crystallize to form ionically bonded single-crystalline systems, are a class of photoactive materials with exceptional structure and property tunability. Zero-dimensional organic metal halide hybrids containing highly luminescent metal halide polyhedrons can be used as scintillation materials.

Organic metal halide hybrids, such as (C₃₈H₃₄P₂)MnBr₄ and (C₃₆H₃₀NP₂)₂SbC₁₅, can be used for X-ray scintillators (see, e.g.; Xu et al., Highly efficient eco-friendly X-ray scintillators based on an organic manganese halide. Nat Commun 11, 4329, 2020; and He et al., Highly stable organic antimony halide crystals for X-ray scintillation. ACS Materials Lett 2, 633-638, 2020; both of which are hereby incorporated herein by reference in their entireties). The scintillation properties of these materials with great response linearity to dose rate, high light yields of up to 80,000 photons per mega electron Volt (photons/MeV), and low detection limits of down to 72.8 nGyₐᵢᵣ/s, are generally better than those of halide perovskite nanocrystals and most of today's commercially available scintillators. However, the long luminescent decay lifetimes from metal halide species is on the order of microseconds and milliseconds, which is not desirable for many applications. Thus, there is a need in the art for scintillation materials that are suitable for applications that benefit for relatively short luminescent decay times, improved light yield to decay lifetime ratios, relatively low detection limits, and/or a combination thereof.

Embodiments of the subject invention address this need by providing 0D organic metal halide hybrid-based scintillation materials (e.g., (TPA-P)₂ZnBr₄), in which at least one metal halide anion acts as an X-ray sensitizer and at least one organic cation (e.g., AIE organic cation) acts as a light emitter. Embodiments also provide new material design principles for high performance low-cost eco-friendly scintillation materials based on organic metal halide hybrids. In some embodiments, the combination of high Z metal halide anions with highly luminescent organic cations (e.g., AIE organic cations) can permit organic-inorganic hybrid systems with strong X-ray absorption and fast sensitized radioluminescence in the solid state. With this design principle, 0D organic metal halide hybrid materials (e.g., (TPA-P)₂ZnBr₄) can be synthesized and characterized, exhibiting a high light yield (e.g., about 15,000 photons/MeV) and a short decay lifetime (e.g., about 9.96 ns).

The organic metal halide hybrid scintillators of embodiments of the subject invention also exhibit a low limit of detection (e.g., no more than 25 nGyₐᵢᵣ/s, such as no more than 21.3 nGyₐᵢᵣ/s) and an excellent response linearity over a wide range of X-ray dose rates, making them highly promising for non-destructive radiographic imaging. Embodiments of the subject invention provide a new strategy to achieve molecular sensitization in ionically bonded organic-inorganic hybrid systems, and expand the utility and tunability of functional organic molecules in these hybrid systems for useful optoelectronic applications.

In an embodiment, a method of fabricating a scintillation material can include contacting (i) a triaryl amine substituted with a first electron withdrawing group, and (ii) a pyridine substituted with a second electron withdrawing group to form an intermediate product. The phrase “triaryl amine” refers to a tertiary amine atom substituted with three aryl groups. Each aryl group may be independently selected from a C1-C20 hydrocarbyl that includes an aryl moiety. Each aryl group may be the same or different. In some embodiments, the triaryl amine is a triphenyl amine. In some embodiments, the first electron withdrawing group is a halide, such as bromide. One or more of the aryl groups of a triaryl amine may be substituted, at any position, with the first electron withdrawing group. In some embodiments, the triaryl amine substituted with a first electron withdrawing group is as shown in formula (I) below.

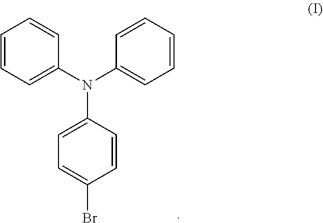 [SMILES: Brc1ccc(N(c2ccccc2)c2ccccc2)cc1]

The pyridine substituted with a second electron withdrawing group may include any pyridine moiety substituted, at any position, with the second electron withdrawing group. The first electron withdrawing group and the second electron withdrawing group may be the same or different. The second electron withdrawing group may include a boron atom. In some embodiments, the second electron withdrawing group is —B(OH)₂. In some embodiments, the pyridine substituted with a second electron withdrawing group is as shown in formula (II) below.

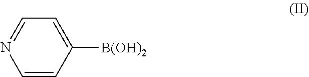

In some embodiments, a method of fabricating a scintillation material can further include contacting the intermediate product and an alkyl halide to form an organic halide salt. As used herein, the phrase “alkyl halide” refers to a C1-C20 hydrocarbyl substituted with at least one halide, such as bromide. In some embodiments, the alkyl halide is a C2-C5 alkyl halide. In some embodiments, the alkyl halide is propyl bromide. In some embodiments, the organic halide salt is TPA-PBr. In some embodiments, the a method of fabricating a scintillation material can also include: providing a precursor liquid in which the organic halide salt and a metal halide salt are disposed; and contacting the precursor liquid with an antisolvent to form an organic-inorganic hybrid scintillation material. Any effective antisolvent may be used in the methods described herein. In some embodiments, the antisolvent is diethyl ether. The metal halide salt can be, for example, ZnBr₂. In some embodiments, a mole ratio of the organic halide salt to the metal halide salt is in a range of 0.5:1 to 3.5:1, such as 1:1 to 3:1, 1.5:1 to 2.5:1. The mole ratio the organic halide salt to the metal halide salt can be, for example, 2:1 or about 2:1.

In some embodiments, the organic-inorganic hybrid scintillation material is a 0D organic-inorganic hybrid scintillation material, such as 4-(4-(diphenylamino) phenyl)-1-(Propyl)-pyrindin-lium zinc halide ((TPA-P)₂ZnX₄). In certain embodiments, the organic-inorganic hybrid scintillation material can be (TPA-P)₂ZnBr₄.

In some embodiments, the organic-inorganic hybrid scintillation material can have a light yield of, for example, at least 15,000 photons/MeV, at least 30,000 photons/MeV, or at least 36,000 photons/MeV. The organic-inorganic hybrid scintillation material can have a decay lifetime in a range of 1 ns to 100 ns, for example, 2 ns to 10 ns, 2 ns to 7 ns, 2 ns, to 5 ns, 2 ns to 4 ns, 3 ns to 4 ns, or 3.4 ns to 3.6 ns. The organic-inorganic hybrid scintillation material can have a light yield to decay time ratio of, for example, at least 1,000 photons/MeV-ns, at least 5,000 photons/MeV-ns, at least 10,000 photons/MeV-ns, or about 1,000 photons/MeV-ns.

The phrases “C1-C20 hydrocarbyl,” and the like, as used herein, generally refer to aliphatic, aryl, or arylalkyl groups containing 1 to 20 carbon atoms. Examples of aliphatic groups, in each instance, include, but are not limited to, an alkyl group, a cycloalkyl group, an alkenyl group, a cycloalkenyl group, an alkynyl group, an alkadienyl group, a cyclic group, and the like, and includes all substituted, unsubstituted, branched, and linear analogs or derivatives thereof, in each instance having 1 to about 20 carbon atoms. Examples of alkyl groups include, but are not limited to, methyl, ethyl, propyl, isopropyl, n-butyl, t-butyl, isobutyl, pentyl, hexyl, isohexyl, heptyl, 4,4-dimethylpentyl, octyl, 2,2,4-trimethylpentyl, nonyl, decyl, undecyl and dodecyl. Cycloalkyl moieties may be monocyclic or multicyclic, and examples include cyclopropyl, cyclobutyl, cyclopentyl, cyclohexyl, and adamantyl. Additional examples of alkyl moieties have linear, branched and/or cyclic portions (e.g., 1-ethyl-4-methyl-cyclohexyl). Representative alkenyl moieties include vinyl, allyl, 1-butenyl, 2-butenyl, isobutylenyl, 1-pentenyl, 2-pentenyl, 3-methyl-1-butenyl, 2-methyl-2-butenyl, 2,3-dimethyl-2-butenyl, 1-hexenyl, 2-hexenyl, 3-hexenyl, 1-heptenyl, 2-heptenyl, 3-heptenyl, 1-octenyl, 2-octenyl, 3-octenyl, 1-nonenyl, 2-nonenyl, 3-nonenyl, 1-decenyl, 2-decenyl and 3-decenyl. Representative alkynyl moieties include acetylenyl, propynyl, 1-butynyl, 2-butynyl, 1-pentynyl, 2-pentynyl, 3-methyl-1-butynyl, 4-pentynyl, 1-hexynyl, 2-hexynyl, 5-hexynyl, 1-heptynyl, 2-heptynyl, 6-heptynyl, 1-octynyl, 2-octynyl, 7-octynyl, 1-nonynyl, 2-nonynyl, 8-nonynyl, 1-decynyl, 2-decynyl and 9-decynyl. Examples of aryl or arylalkyl moieties include, but are not limited to, anthracenyl, azulenyl, biphenyl, fluorenyl, indan, indenyl, naphthyl, phenanthrenyl, phenyl, 1,2,3,4-tetrahydro-naphthalene, tolyl, xylyl, mesityl, benzyl, and the like, including any heteroatom substituted derivative thereof.

Unless otherwise indicated, the term “substituted,” when used to describe a chemical structure or moiety, refers to a derivative of that structure or moiety wherein (i) a multi-valent non-carbon atom (e.g., oxygen, nitrogen, sulfur, phosphorus, etc.) is bonded to one or more carbon atoms of the chemical structure or moiety (e.g., a “substituted” C4 hydrocarbyl may include, but is not limited to, diethyl ether moiety, a methyl propionate moiety, an N,N-dimethylacetamide moiety, a butoxy moiety, etc., and a “substituted” aryl C12 hydrocarbyl may include, but is not limited to, an oxydibenzene moiety, a benzophenone moiety, etc.) or (ii) one or more of its hydrogen atoms (e.g., chlorobenzene may be characterized generally as an aryl C6 hydrocarbyl “substituted” with a chlorine atom) is substituted with a chemical moiety or functional group such as alcohol, alkoxy, alkanoyloxy, alkoxycarbonyl, alkenyl, alkyl (e.g., methyl, ethyl, propyl, t-butyl), alkynyl, alkylcarbonyloxy (—OC(O)alkyl), amide (—C(O)NH— alkyl- or -alkylNHC(O)alkyl), tertiary amine (such as alkylamino, arylamino, arylalkylamino), aryl, aryloxy, azo, carbamoyl (—NHC(O)O-alkyl- or —OC(O)NH-alkyl), carbamyl (e.g., CONH2, as well as CONH-alkyl, CONH-aryl, and CONH-arylalkyl), carboxyl, carboxylic acid, cyano, ester, ether (e.g., methoxy, ethoxy), halo, haloalkyl (e.g., —CCl3, —CF3, —C(CF3)3), heteroalkyl, isocyanate, isothiocyanate, nitrile, nitro, oxo, phosphodiester, sulfide, sulfonamido (e.g., SO2NH2), sulfone, sulfonyl (including alkylsulfonyl, arylsulfonyl and arylalkylsulfonyl), sulfoxide, thiol (e.g., sulfhydryl, thioether) or urea (—NHCONH-alkyl-).

While certain aspects of conventional technologies have been discussed to facilitate disclosure of various embodiments, applicants in no way disclaim these technical aspects, and it is contemplated that the present disclosure may encompass one or more of the conventional technical aspects discussed herein.

The present disclosure may address one or more of the problems and deficiencies of known methods and processes. However, it is contemplated that various embodiments may prove useful in addressing other problems and deficiencies in a number of technical areas. Therefore, the present disclosure should not necessarily be construed as limited to addressing any of the particular problems or deficiencies discussed herein.

The terms “a,” “an,” and “the” are intended to include plural alternatives, e.g., at least one. For instance, the disclosure of “an antisolvent”, “a triaryl amine”, and the like, is meant to encompass one, or mixtures or combinations of more than one antisolvent, triaryl amine, and the like, unless otherwise specified.

Various numerical ranges are disclosed herein. When a range of any type is disclosed or claimed herein, the intent is to disclose or claim individually each possible number that such a range could reasonably encompass, including end points of the range as well as any sub-ranges and combinations of sub-ranges encompassed therein, unless otherwise specified.

When ranges are used herein, combinations and subcombinations of ranges (e.g., any subrange within the disclosed range) and specific embodiments therein are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to embodiments of the invention.

### Example 1—Scintillation Mechanism and Design

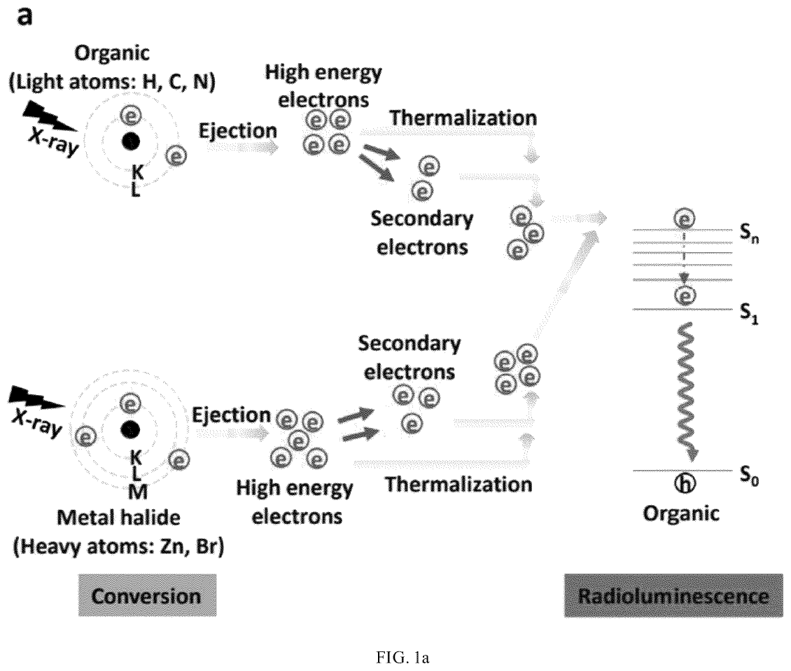

Upon X-ray interactions with scintillation materials, electrons are ejected from the inner shells of the constituent atoms through various physical processes, including photoelectric effect and Compton scattering. More electrons are produced due to secondary effects, such as Auger processes and electron-electron scattering, leading to an avalanche of secondary electrons and holes. This conversion of X-rays to charge carriers takes place within sub picoseconds, which is followed by thermalization to produce low-energy holes and electrons at the valence and conduction bands, respectively. The recombination of charge carriers results in radioluminescence from the emission centers, which could be fluorescent organic emitters, as shown in FIG. 1a. Organic scintillators with C, H, and N as predominant elemental constituents possess weak X-ray attenuation and exhibit low light yields. Effective approaches to improving the scintillation performance of organic scintillators include: (i) introducing atoms of high atomic weights into the molecules; and (ii) sensitization by high Z species, for instance, metal halides.

In order to achieve a combination of high radiation absorption, high light yield, fast responsivity with short decay lifetimes, and low cost of mass production, embodiments of the subject invention provide new 0D organic metal halide hybrids containing metal halides as a sensitizer and fluorescent organic cations as an emitter.

FIG. 1b shows a schematic view of a 0D hybrid with anionic metal halide polyhedrons completely isolated and surrounded by organic cations, as well as its sensitized X-ray scintillation process, according to an embodiment of the subject invention. While both organic cations and high-Z metal halide anions are capable of absorbing X-rays to generate charge carriers, the much higher X-ray attenuation of metal halides can allow them to capture the majority of X-rays and generate a significantly higher amount of charge carriers than organic cations can generate.

As highly efficient charge transfer is permitted between metal halides and organic cations, due to the ionic bond distance proximity in 0D organic metal halide hybrids, the charge carriers and excitons generated in metal halides can be efficiently redirected to organic cations to enable radioluminescence with short decay lifetimes.

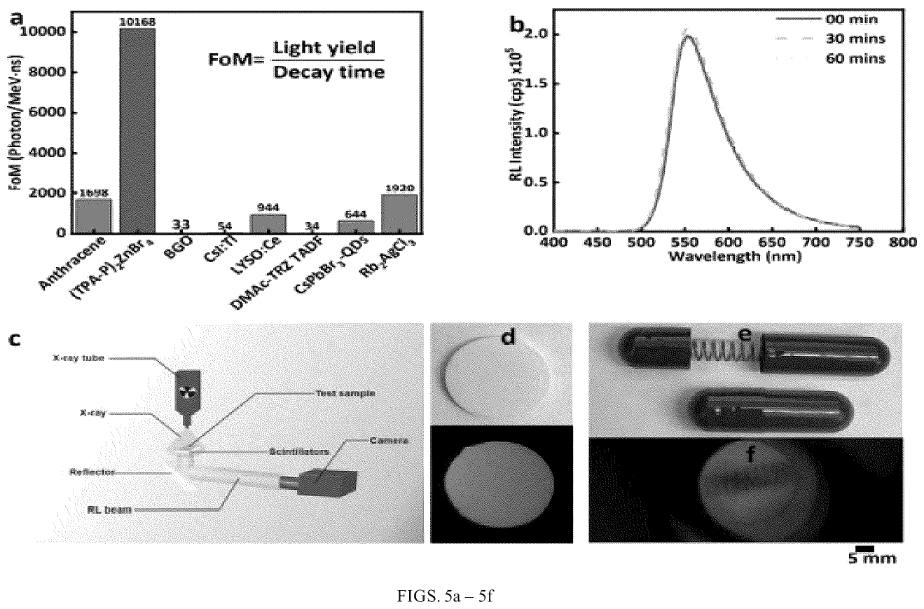

In this example, ZnBr₂ was chosen for the preparation of a 0D organic metal halide hybrid, considering its low cost, low toxicity (see also the table in FIG. 6), and wide bandgap. For the light emitting organic species, a simple AIE organic bromide salt (4-(4-(diphenylamino) phenyl)-1-(propyl)-pyrindin-lium bromide (TPA-PBr)) was designed, considering its capability of generating luminescence with a high quantum yield in the solid state. Unlike typical fluorescent materials that suffer from low luminescence quantum yields due to self-absorption and concentration quenching in the solid state, AIE molecules possess the unique property of intense emissions in their aggregated states due to the restriction of intermolecular motions (see also, e.g.; Wang et al., Aggregation-induced emission luminogens sensitized quasi-2D hybrid perovskites with unique photoluminescence and high stability for fabricating white light-emitting diodes. Adv Sci (Weinh) 8, e2100811, 2021; and Zhao et al., Aggregation-induced emission: new vistas at the aggregate level. Angew Chem Int Ed Engl 59, 9888-9907, 2020; both of which are hereby incorporated by reference herein in their entireties).

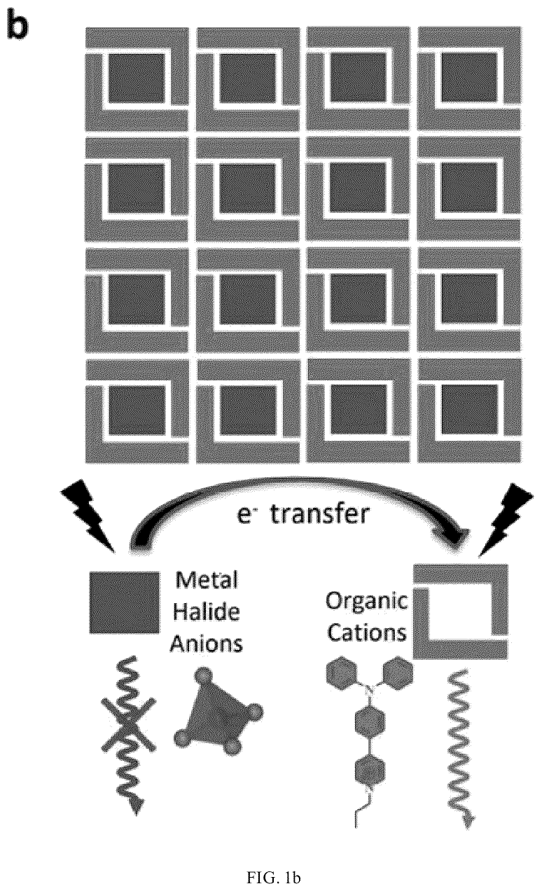

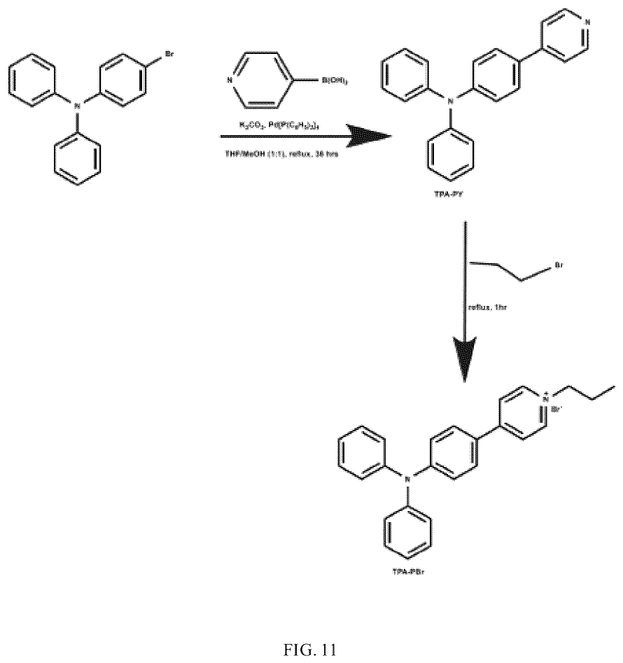

The synthetic schemes for the preparation of TPA-PBr and 0D organic metal halide (TPA-P)₂ZnBr₄, are shown in FIGS. 2a and 2b. An electron-rich triphenylamine unit was coupled with electron-deficient pyridine to achieve an AIE active donor-acceptor system, which was converted into organic bromide salt (TPA-PBr) through a Menshutkin reaction with propyl bromide. (TPA-P)₂ZnBr₄ single crystals were prepared by an antisolvent diffusion method, in which diethyl ether effectively diffused into a dimethylformamide (DMF) precursor solution containing TPA-PBr and ZnBr₂ at a molar ratio of 2:1 at room temperature. The details of synthesis, purification, ¹H NMR, and mass spectroscopic analysis of the products are shown in FIGS. 11-16. FIGS. 2c and 2d show the products under ambient light with TPA-PBr in the form of yellow powder and (TPA-P)₂ZnBr₄ transparent yellow crystals.

Single-crystal X-ray diffraction (SCXRD) was used to characterize the crystal structures of prepared TPA-PBr (FIG. 2e) and (TPA-P)₂ZnBr₄ (FIG. 2f). The SCXRD analysis reveals that both TPA-PBr and (TPA-P)₂ZnBr₄ crystallized into a monoclinic space group P2₁ and I2/a, respectively. While TPA-PBr had a unit cell volume of around 10271.49 Angstroms (Å) and a density of 1.24 grams per cubic centimeter (g/cm³), (TPA-P)₂ZnBr₄ showed a more compact structure with unit cell volume and density of 4839.88 Å and 1.54 g/cm³, respectively.

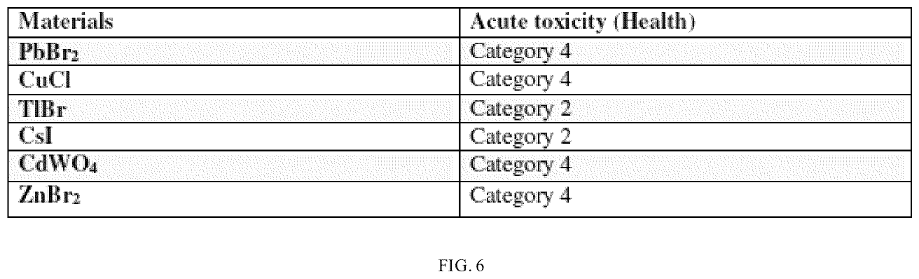

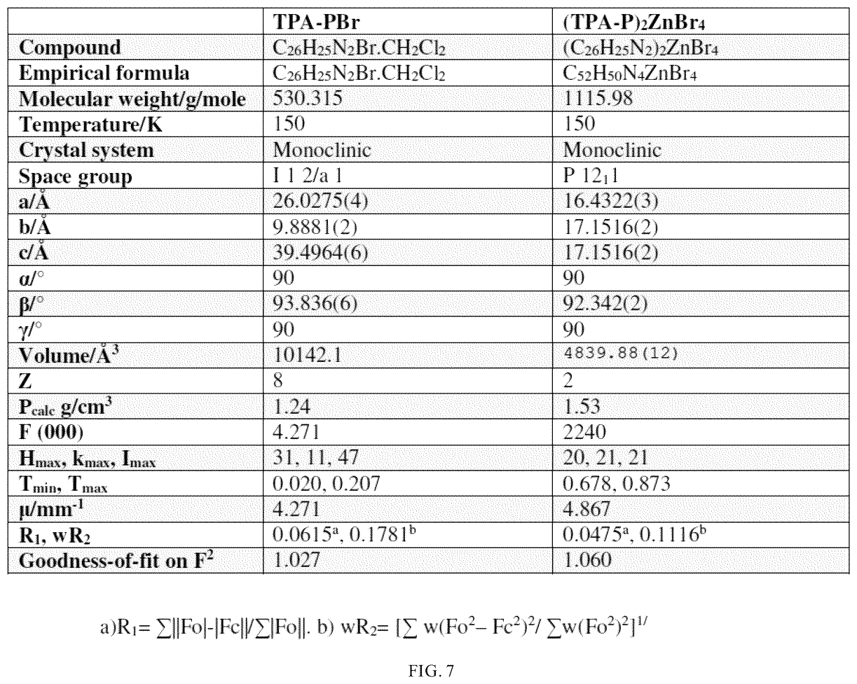

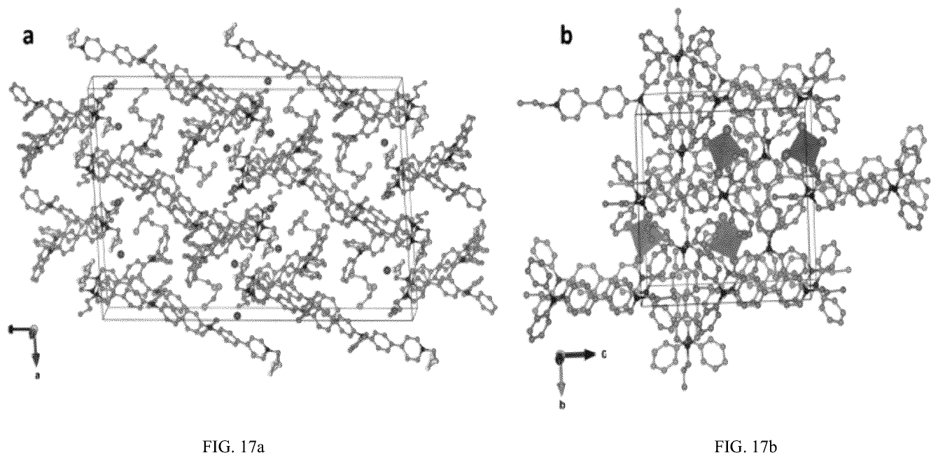

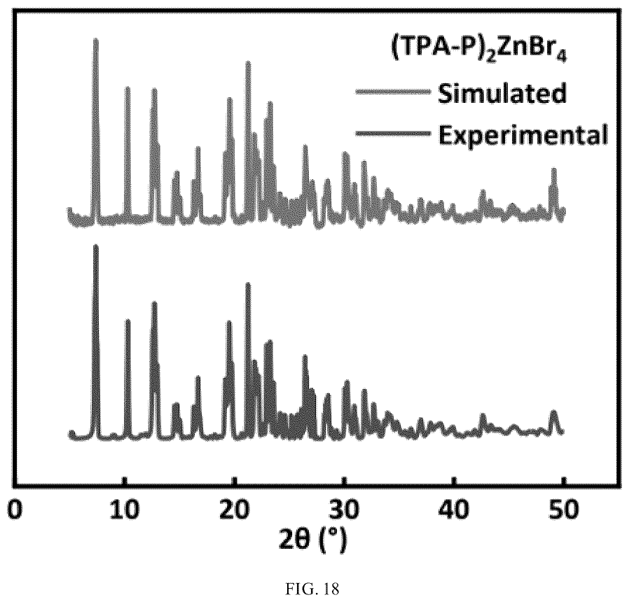

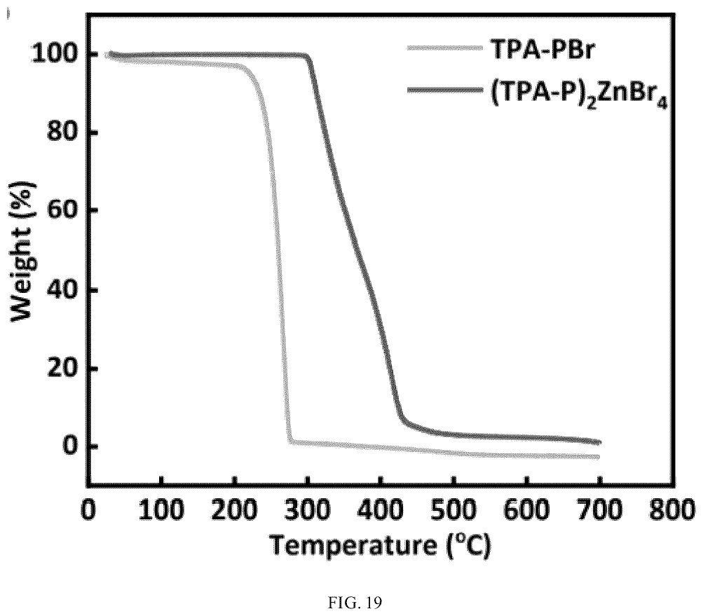

More detailed crystallographic results are provided in FIGS. 17a and 17b and the table in FIG. 7. The 0D structure at the molecular level was clearly observed in (TPA-P)₂ZnBr₄ with ZnBr₄²⁻ tetrahedrons completely isolated and surrounded by TPA-P⁺ cations. The zinc center adopted a typical tetra-coordinated geometry bonded to the bromide ions, with an average Zn—Br bond length of 2.41 Å and bond angle of 109.740 (see also the table in FIG. 8). Powder XRD analysis of (TPA-P)₂ZnBr₄ gave the identical results as those simulated from SCXRD (see FIG. 18), which likely suggested the high phase purity of prepared single crystals. Thermogravimetric analysis (TGA) of TPA-PBr and (TPA-P)₂ZnBr₄ (see FIG. 19) revealed high thermal stability of both materials with onset weight loss at 211° C. and 296° C., respectively.

### Example 2—Photophysical Properties

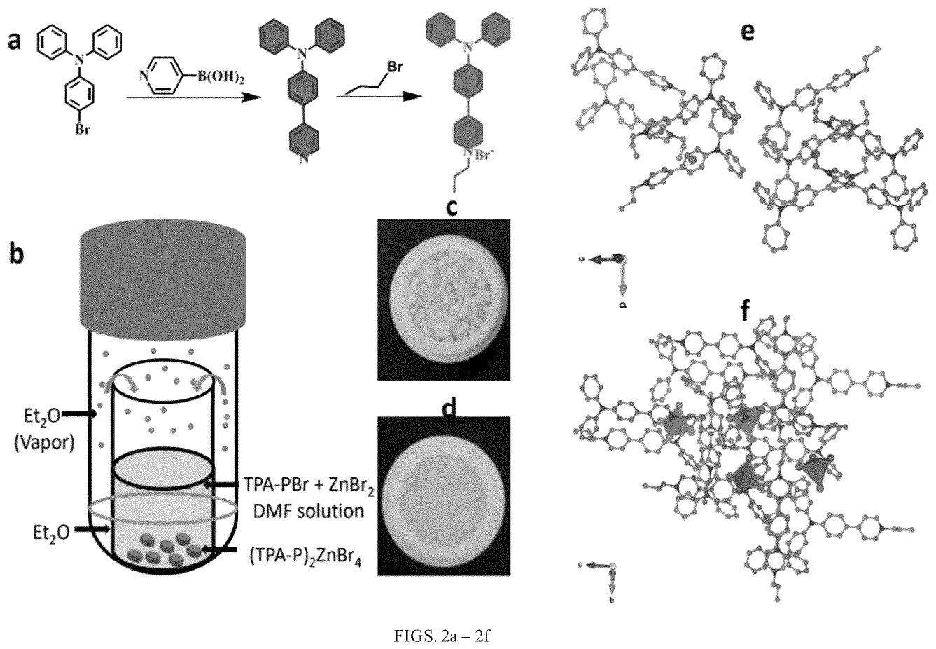

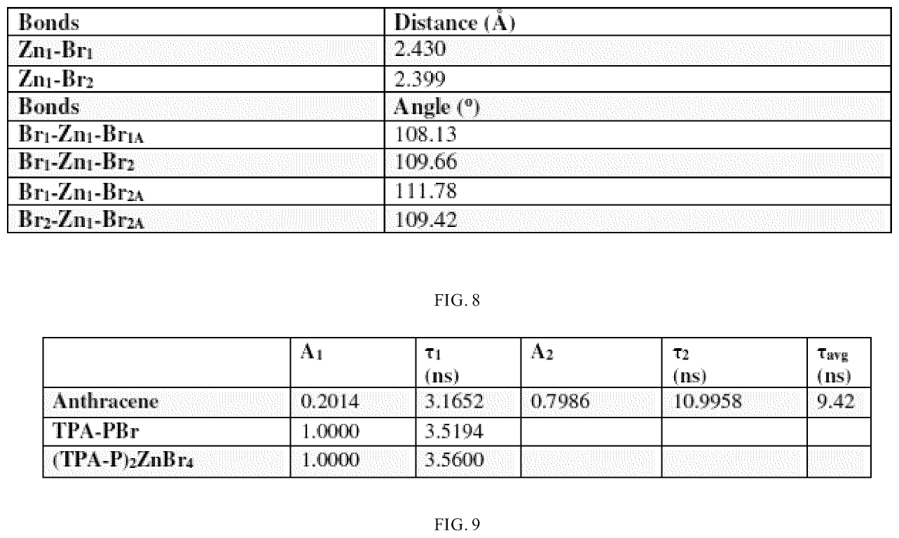

The photophysical properties of TPA-PBr and (TPA-P)₂ZnBr₄ were fully characterized and compared to a commercially available organic scintillator, anthracene. FIG. 3a shows the emission and excitation spectra of TPA-PBr, (TPA-P)₂ZnBr₄, and anthracene, as well as their images under UV light (at 365 nm). Unlike anthracene showing multiple emission peaks in the blue region, both TPA-PBr and (TPA-P)₂ZnBr₄ showed similar featureless yellowish-green emissions peaked at around 550 nm under 365 nm excitation. The slightly redshifted emission of (TPA-P)₂ZnBr₄ as compared to TPA-PBr was attributed to the more compact molecular packing of (TPA-P)₂ZnBr₄, which also affected the absorption, as shown in FIG. 3b. Time-resolved photoluminescence (TRPL) spectroscopy was used to further study the recombination decay kinetics. As shown in FIG. 3c, both TPA-PBr and (TPA-P)₂ZnBr₄ showed mono-exponential decays with lifetimes of 3.52 ns and 3.56 ns, respectively, whereas anthracene exhibited biexponential decay with an average decay lifetime of 9.42 ns (see the table in FIG. 9 for fitting parameters).

The similarity of emissions and decay dynamics of TPA-PBr and (TPA-P)₂ZnBr₄ suggested their same origin from TPA-P⁺ with intramolecular charge transfer (ICT) states, while the counter anions (Br and ZnBr₄²⁻) had minimum impact on the photophysical properties of these materials through the effects on the molecular packing of TPA-P⁺ cations.

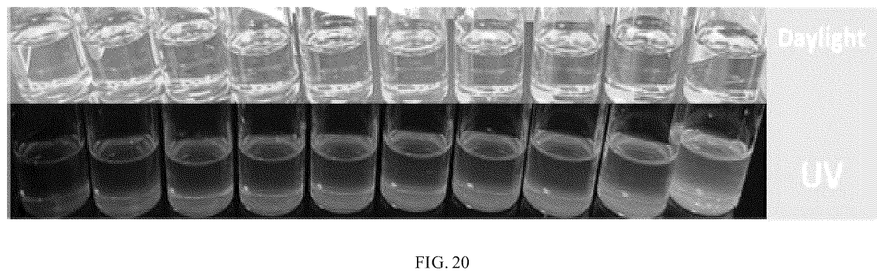

The photoluminescence quantum yields (PLQYs) of anthracene, TPA-PBr, and (TPA-P)₂ZnBr₄ in solid state were measured to be 58%, 56%, and 71%, respectively (FIG. 3d). The high PLQYs of TPA-PBr and (TPA-P)₂ZnBr₄ can be attributed to their AIE nature. The more compact structure of (TPA-P)₂ZnBr₄ lead to its higher PLQY than that of TPA-PBr. In order to confirm the AIE nature of TPA-PBr, its emission properties in various DMSO/toluene solvent systems were characterized, in which different degrees of aggregates could be generated by controlling the ratios of the two solvents. No emission was recorded for the sample in the solvent system containing pure DMSO, while emission intensity increased upon the addition of toluene to the solvent system, consistent with typical AIE behavior (see FIG. 20). The high PLQYs and short decay lifetimes of TPA-PBr and (TPA-P)₂ZnBr₄ afforded their potential to outperform anthracene in X-ray scintillation.

### Example 3—X-Ray Scintillation

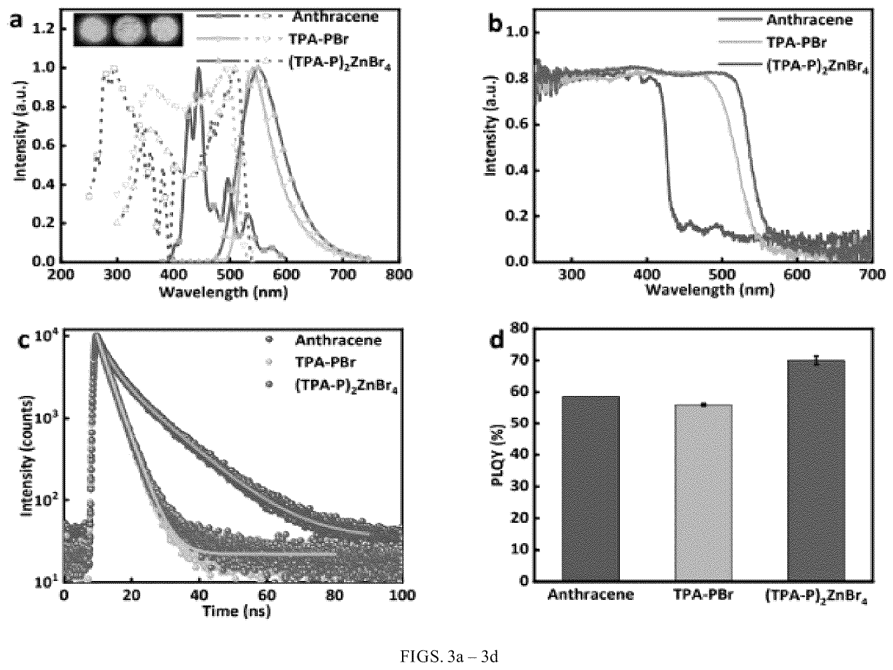

Mass absorption coefficient and effective Z, theoretical pointers to the X-ray absorption ability, were evaluated for TPA-PBr, (TPA-P)₂ZnBr₄, and anthracene. Using the photon cross-section database available from the national institute of standard testing (NIST), the mass absorption coefficient of each of anthracene, TPA-PBr, and (TPA-P)₂ZnBr₄ were compared across a broad range of photon energies (FIG. 4a) (see also, Berger et al., XCOM: photon cross sections database NIST, PML, Radiation Physics Division, 2013; which is hereby incorporated by reference herein in its entirety). At the energy range of <1 keV, all three materials showed similar absorption coefficients, but a drastic difference in absorption appeared as the energy increased.

Anthracene had far less absorption than TPA-PBr and (TPA-P)₂ZnBr₄ in the high energy range, and (TPA-P)₂ZnBr₄ showed the highest absorption across all energy ranges. Two sharp absorptions were observed for TPA-PBr, corresponding to the K absorption edges of phosphorus and bromine, while three were observed for (TPA-P)₂ZnBr₄, with the third corresponding to that of zinc. Energy-dependent effective Z was calculated using software (see also Taylor et al., Robust calculation of effective atomic numbers: The auto-Zeff software, Medical Physics 39, 1769-1778, 2012; which is hereby incorporated by reference herein in its entirety).

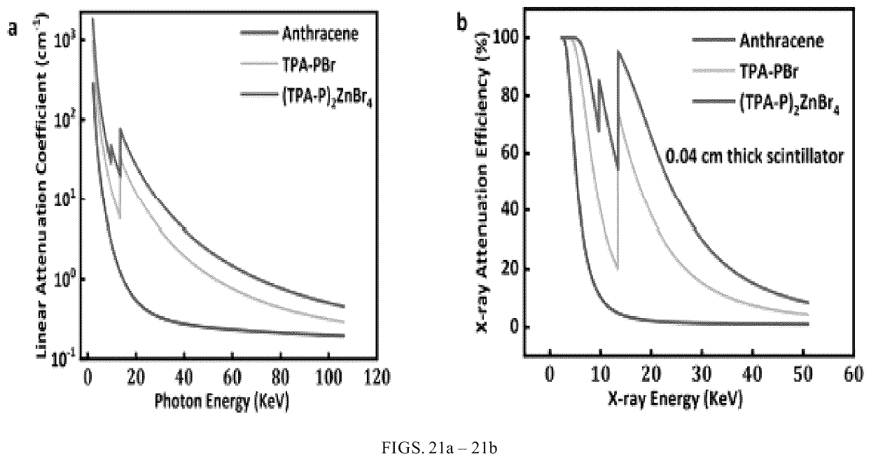

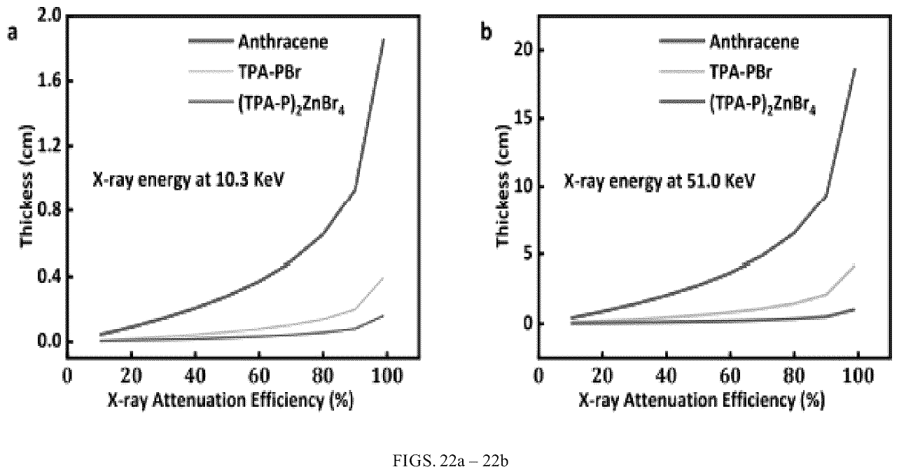

As shown in FIG. 4b, at the photoelectric regime of <1 MeV, (TPA-P)₂ZnBr₄ exhibited the highest effective Z and anthracene the lowest. These trends can be attributed to the low atomic weight C and H as constituents of anthracene with few electrons available for radio-physical interactions, while many higher atomic weight atoms (e.g., Br, Zn) are available in TPA-PBr and (TPA-P)₂ZnBr₄ (see also FIGS. 21a, 21b, 22a, and 22b for calculated linear attenuation coefficient and X-ray attenuation efficiency).

Upon X-ray irradiation, anthracene showed bright bluish emission, while TPA-PBr and TPA-P)₂ZnBr₄ showed greenish-yellow emissions (see also FIG. 4c inset). An X-ray generator (Moxtek Mini tube, W target, 4W) coupled with Edinburg FS5 fluorescence spectrophotometer was used to further characterized the radioluminescence. As shown in FIG. 4c, the radioluminescence spectra of all three samples were almost identical to their photoluminescence spectra in FIG. 3a, which suggested the same luminescence processes. This was not atypical because radioluminescence and photoluminescence differ only in the way of charge carrier generation. In order to quantify the radioluminescence light outputs of developed materials, composite samples with them blended with optically clear polydimethylsiloxane (PDMS) in various mass concentrations were prepared (FIG. 4d). It was found that anthracene had a maximum integrated intensity at 30 milligrams per milliliter (mg/ml) with a decrease at 50 mg/ml, which could be due to concentration quenching. On the other hand, both TPA-PBr and (TPA-P)₂ZnBr₄ showed a steady increase in radioluminescence with no concentration quenching, due to their AIE nature. In all cases, radioluminescence of samples based on (TPA-P)₂ZnB₄ showed the highest intensity, which could be attributed to its highest capability of X-ray absorption and PLQY.

These results confirmed the effectiveness of the sensitization strategy, in which AIE organic cations were sensitized by ionically bonded metal halides to exhibit dramatically improved radioluminescence.

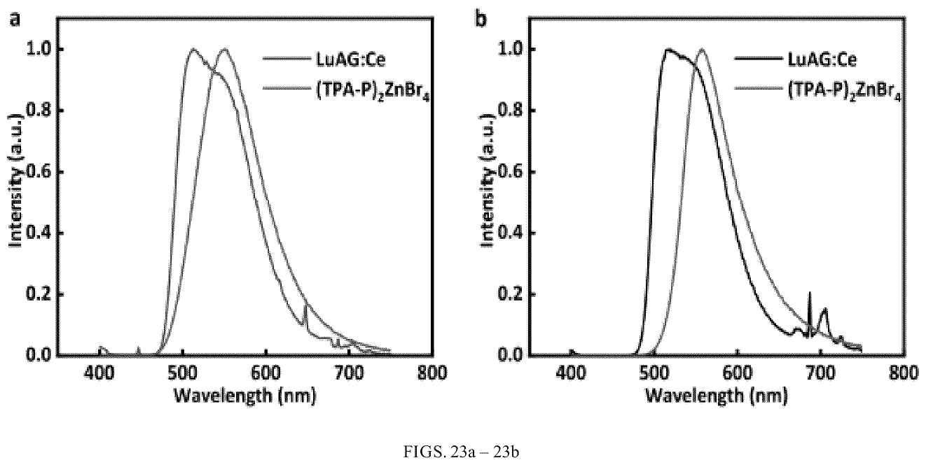

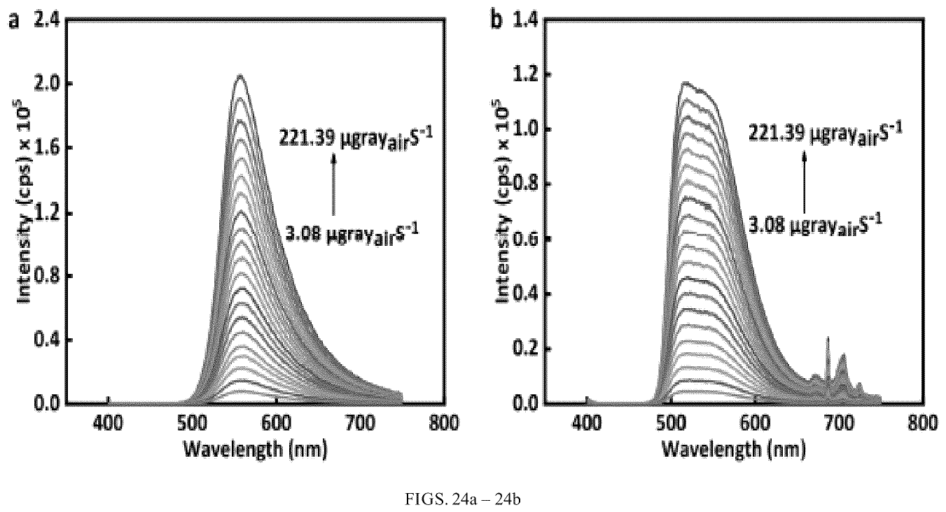

In order to further characterize the scintillation performance of (TPA-P)₂ZnBr₄, a commercially available inorganic scintillator, cerium-doped lutetium aluminum garnet (LuAG:Ce) with a light yield of 25,000 photons/MeV was used as a reference, considering its similar photoluminescence (PL) and radioluminescence (RL) as those of (TPA-P)₂ZnBr₄ (see FIGS. 23a and 23b). The light yield of (TPA-P)₂ZnBr₄ was estimated to be about 36,200 photons/MeV, which is about 1.48 times higher than that of LuAG:Ce (FIG. 4e). Across the measured dose rates from 221.39 μGyₐᵢᵣ/s to 3.08 μGyₐᵢᵣ/s, both LuAG:Ce and (TPA-P)₂ZnBr₄ exhibited linear responses to X-ray, with (TPA-P)₂ZnBr₄ having a larger slope (FIGS. 4f, 24a, and 24b). The detection limit was determined to be 21.3 nGyₐᵢᵣ/s, using the 3σ/slope method, which was about 258 times lower than the X-ray diagnostic dose rate requirement (5.5 μGyₐᵢᵣ/s). Because the luminescent stages of radioluminescence and photoluminescence were the same, the decay lifetime of radioluminescence was expected to be similar to that of photoluminescence, thus, about 3.56 ns for (TPA-P)₂ZnBr₄.

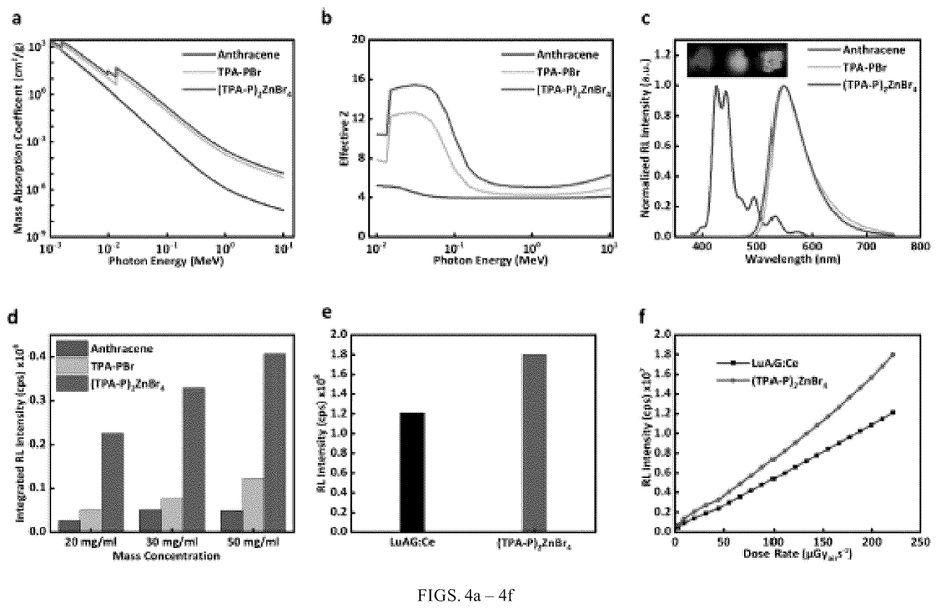

With a high light yield (about 36,200 photons/MeV) and a short decay lifetime (about 3.56 ns), a record value of light yield versus decay time (10,168 photons/MeV-ns) (Figure of Merit (FoM)) was achieved for (TPA-P)₂ZnBr₄, which was much higher than that of commercially available organic and all-inorganic scintillators, as well as all recently reported scintillation materials (FIG. 5a).

In addition to high scintillation properties, excellent material stability is needed for scintillation materials to be used practically. The radioluminescence of (TPA-P)₂ZnBr₄ was tested at 100° C. for 30 minutes and 60 minutes, with the results presented in FIG. 5b. The radioluminescence at 221.39 μGyₐᵢᵣ/s remained largely unchanged after 60 minutes, which showed its excellent stability under harsh thermal conditions. All the superior scintillation properties of (TPA-P)₂ZnBr₄ show that it can be applicable in dynamic imaging and dosimetry. A simple lab-built X-ray imaging set-up, as shown in FIG. 5c, was used to demonstrate the use of (TPA-P)₂ZnBr₄ for X-ray radiography. In order to make scintillation films suitable for X-ray imaging, (TPA-P)₂ZnBr₄ in optically clear polydimethylsiloxane (6 mg/ml, 6.0 wt %) was ground, which exhibited the same photophysical properties as single crystals (see FIG. 5d). An opaque capsule with a built-in metallic spring, as shown in FIG. 5e, was placed between the X-ray source and the scintillator film. With X-ray irradiation on the sample, an image was created on the scintillator film, which was then deflected to a digital camera. FIG. 5f clearly shows the X-ray image of the metallic spring in the opaque capsule, demonstrating the suitability of (TPA-P)₂ZnBr₄ for X-ray radiography.

### Example 4—Materials and Synthesis

Materials: Zinc bromide (99.999%), 4-bromotriphenylamine (97%), pyridine-4-boronic acid (90%), tetrakis(triphenylphosphine)-palladium(0), (99%), potassium carbonate (≥99.0%), tetrahydrofuran (THF, ≥99.9%), methanol (MeOH, ≥99.9%), dichloromethane (DCM, ≥99.8%), and propyl bromide (99%) were all purchased from Sigma Aldrich. N, N-Dimethylformamide (DMF≥99.8%), and diethyl ether (Et₂O, ≥99.9%) were purchased from VWR. These materials were used without further purification after purchase. Standard scintillator Ce:LuAG was purchased from Jiaxing AOSITE Photonics Technology Co., Ltd. Two-part polydimethylsiloxane ((C₂H₆OSi)n) EI-1184 optical encapsulant was purchased from Dow.

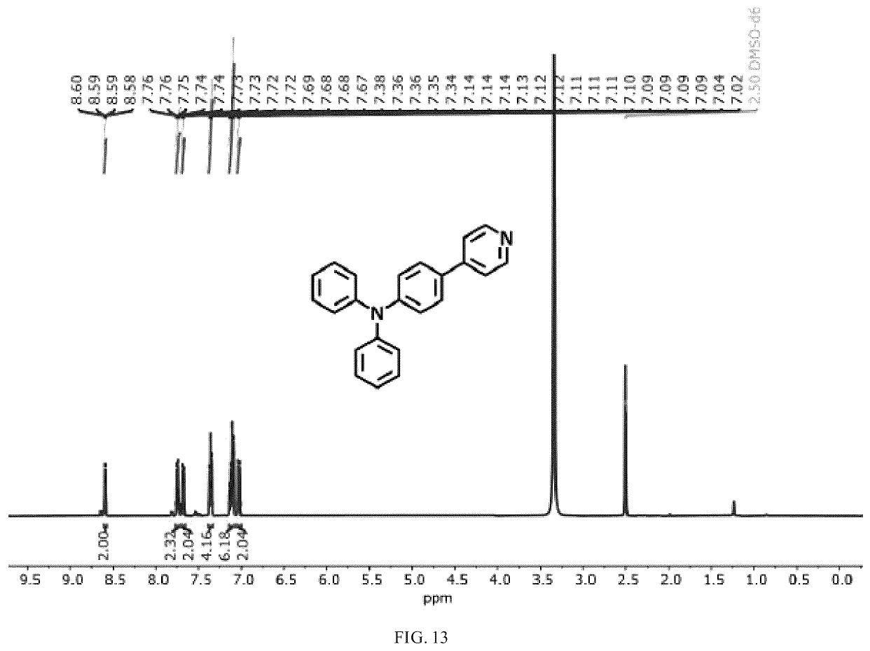

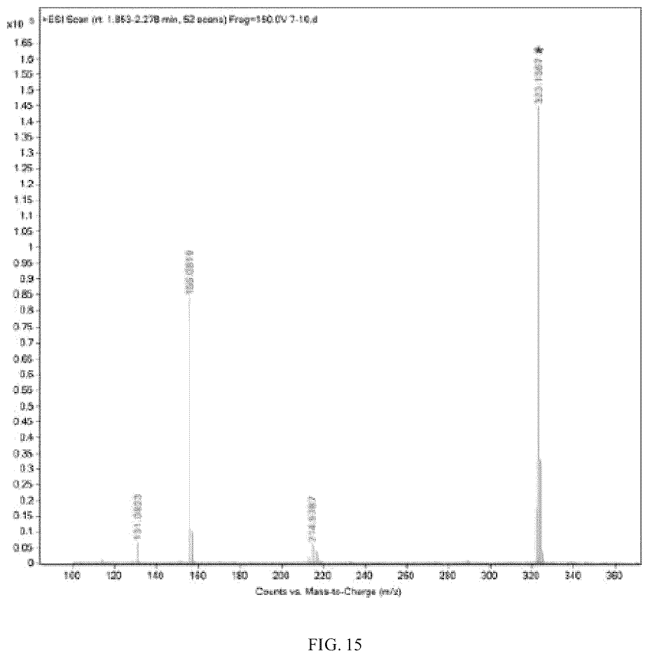

Synthesis of N, N-diphenyl-4-(pyridin-4-yl) aniline (TPA-Py): 4-Bromotriphenylamine (7.4 millimolar (mmol), 324.21 grams per mole (g/mol), 2.4 grams (g)), pyridine-4-boronic acid (12 mmol, 122.92 g/mol, 1.475 g), tetrakis(triphenylphosphine)-palladium(0) (0.297 mmol, 1155 g/mol, 0.344 g), and potassium carbonate (14.4 mmol, 138.21 g/mol, 2 g) were weighed into a clean flask. This was followed by three cycles of repeated purging with nitrogen gas (N₂) and vacuum evacuation. 120 milliliters (ml) of combined solvent (THF:MeOH; 1:1) of THF and MeOH was added with two cycles of purging with N₂ and vacuum evacuation. The mixture was refluxed at 90° C. for 36 hours under an N₂ atmosphere and then concentrated by rotary evaporation. TPA-Py was purified by column chromatography on silica gel with a mixture of petroleum ether and ethyl acetate as the eluent (7:1 by volume) to obtain about 55% TPA-PY white solid yield after recrystallization with DCM. The synthetic scheme is shown in the first part of FIG. 11. ¹H NMR (500 megahertz (MHz), DMSO) δ 8.61-8.57 (m, 2H), 7.78-7.70 (m, 2H), 7.70-7.66 (m, 2H), 7.40-7.32 (m, 4H), 7.16-7.07 (m, 6H), 7.03 (d, J=8.8 Hz, 2H); HRMS (ESI) m/z: found 323.1567. The plots of NMR and mass spectroscopic data can be found in FIGS. 13 and 15, respectively.

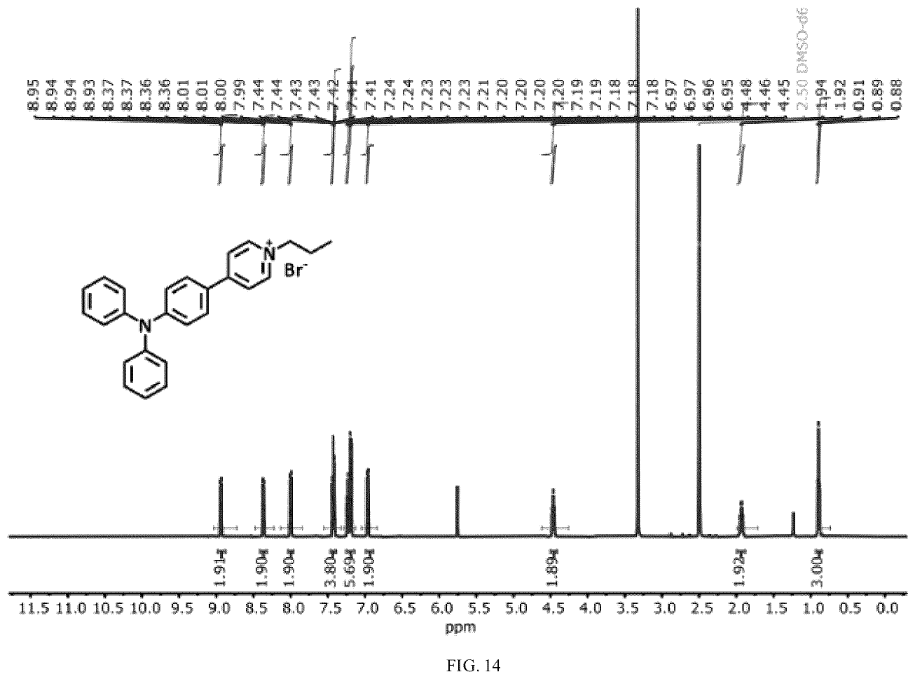

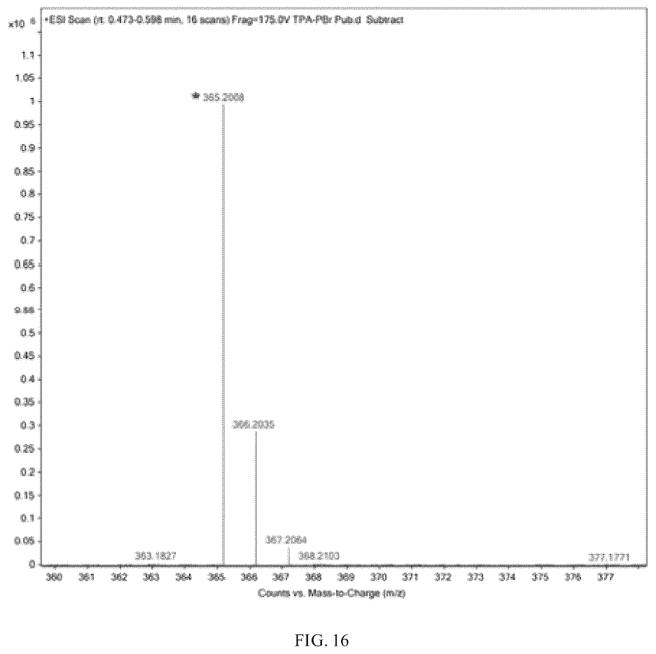

Synthesis of 4-(4-(diphenylamino) phenyl)-1-(Propyl)-pyrindin-lium bromide (TPA-PBr): A mixture of N, N-diphenyl-4-(pyridin-4-yl) aniline (0.62 mmol, 322.14 g/mol, 0.2 g), and propyl bromide (122.9 g/mol, 7 ml) was obtained in a clean reaction flask and refluxed at 90° C. Yellowish TPA-PBr was obtained within a few minutes. The TPA-PBr yield of about 90% was obtained after recrystallization in DCM/DMF/Et₂O. The synthetic scheme is shown in FIG. 11. ¹H NMR (500 MHz, DMSO) δ 8.94 (d, J=7.1 Hz, 2H), 8.37 (d, J=7.0 Hz, 2H), 8.00 (d, J=9.0 Hz, 2H), 7.42 (dd, J=8.4, 7.4 Hz, 4H), 7.29-7.12 (m, 6H), 6.96 (d, J=9.0 Hz, 2H), 4.46 (t, J=7.3 Hz, 2H), 1.93 (q, J=7.3 Hz, 2H), 0.88 (d, J=7.4 Hz, 3H); HRMS (ESI): found 365.2008. The plots of NMR and mass spectroscopic data can be found in FIGS. 14 and 16, respectively.

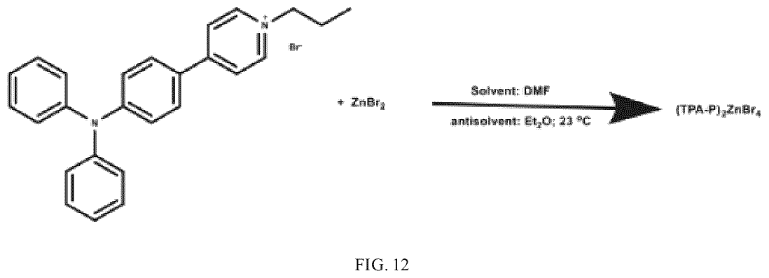

Synthesis of 0D 4-(4-(diphenylamino) phenyl)-1-(Propyl)-pyrindin-lium Zinc tetrabromide (TPA-P)₂ZnBr₄): 2:1 molar ratio of 4-(4-(diphenylamino) phenyl)-1-(Propyl)-pyrindin-lium bromide and zinc bromide were fully dissolved in the appropriate amount of DMF to form a precursor solution. This was followed by diffusion of Et₂O as an antisolvent into the precursor solution until complete crystallization of (TPA-P)₂ZnBr₄ from the solution, indicated by the color change in the precursor solution. This was followed by washing with Et₂O, achieving about 87% yield of (TPA-P)₂ZnBr₄. The synthetic scheme is shown in FIG. 12.

Fabrication of scintillator-polymer composite: A comparison of radioluminescence against the mass concentration of the materials was made by blending the materials in polydimethylsiloxane (PDMS). This was done by evenly mixing the appropriate mass of studied materials in a 1 ml mixture of optically clear PDMS A and B. This was left under vacuum to remove air bubbles and afterward cured at 100° C. for 30 minutes.

Fabrication of X-ray imaging scintillator film: (TPA-P)₂ZnBr₄ bulk crystals were ground with mortar and pestle to fine powder. 264 milligrams (mg) of the ground (TPA-P)₂ZnBr₄ was mixed with 2 ml of diethyl ether and stirred vigorously to completely disperse. 2 ml Part A of optically clear PDMS was added. This was followed by evaporation of the diethyl ether at 100° C. 2 ml Part B was added after the resulting mixture was cooled to room temperature. Afterward, the mixture was poured into a mold and cured at 100° C. for 30 mins.

Structural Characterization: Single-crystal X-ray data for the TPA-PBr and (TPA-P)₂ZnBr₄ were collected using a Rigaku XtaLAB Synergy-S diffractometer equipped with a HyPix-6000HE Hybrid Photon Counting (HPC) detector and dual Mo and Cu microfocus sealed X-ray sources at 150 Kelvin (K). The powder X-ray diffraction (PXRD) patterns were obtained using a Rigaku Smartlab powder diffractometer equipped with a Cu Kα X-ray source. Diffraction patterns were recorded from 5° to 50° 2θ with a step size of 0.05° under a tube current of 44 milliamps (mA) and tube voltage of 40 kilovolts (kV) at room temperature. Further structural analysis of TPA-PY and TPA-PBr was performed using ¹H B500 NMR equipped with a high resolution 5 millimeter (mm) TXI (H-C/N-D) Zg probe. Mass spectrometry was performed using liquid chromatography-time-of-flight/mass spectrometry (LC-TOF/MS) (TOF 6230, LC 1260, Agilent) in a positive electrospray ionization (ESI) mode with a mass range of 100-1700 m/z.

Optical Characterization: Excitation and steady-state PL were carried out using an Edinburgh FS5 steady state spectrometer with a 150 Watt (W) xenon lamp. Time-Correlated Single Photon Counting (TCSPC) was performed for 10,000 counts using excitation from an Edinburgh EPL-360 picosecond pulsed diode laser. The PL decay was fitted using a biexponential decay function for anthracene and a mono-exponential decay function for (TPA-P)₂ZnBr₄. The weighted average lifetime was computed according to equation (1).

$${τ}_{avg} = \frac{\sum {α}_{i} {τ}_{i}^{2}}{\sum {α}_{i} {τ}_{i}} \qquad ( 1 )$$

where τᵢ represents the decay time, and αᵢ represents the amplitude of each component. The table in FIG. 9 shows fitting parameters of the measured samples. PLQY measurement was performed using Hamamatsu Quantaurus-QY Spectrometer (Model C11347-11) equipped with a xenon lamp, an integrating sphere sample chamber, and a charge coupled device (CCD) detector. The PLQYs were calculated using equation (2).

$$η QE = \frac{{I}_{s}}{{ES}_{R} - {ES}_{s}} \qquad ( 2 )$$

where Iₛ the photoluminescence emission spectrum of the sample, and ES_{S} and ES_{R} represent the excitation spectrum for the sample and reference, respectively. Solid sample measurements of absorptance of anthracene, TPA-PBr, and (TPA-P)₂ZnBr₄ were carried out using an Edinburgh FS5 steady state spectrometer with a 150 W xenon lamp and integrating sphere on synchronous scan mode. The absorptance was derived using equation (3).

$$Absorptance : A ( λ ) = \frac{{S}_{ref} ( λ ) - {S}_{sample} ( λ )}{{S}_{ref} ( λ )} \qquad ( 3 )$$

where S_{ref}(λ) is the synchronous scan of the reference and Sₛₐₘₚₗₑ(λ) is the synchronous scan of the sample.

Thermal Stability Analysis: TGA studies were done using a TA instruments Q600 system. The sample was heated from room temperature to 700° C. at a 5° C./min rate under an argon flux of 100 ml/min.

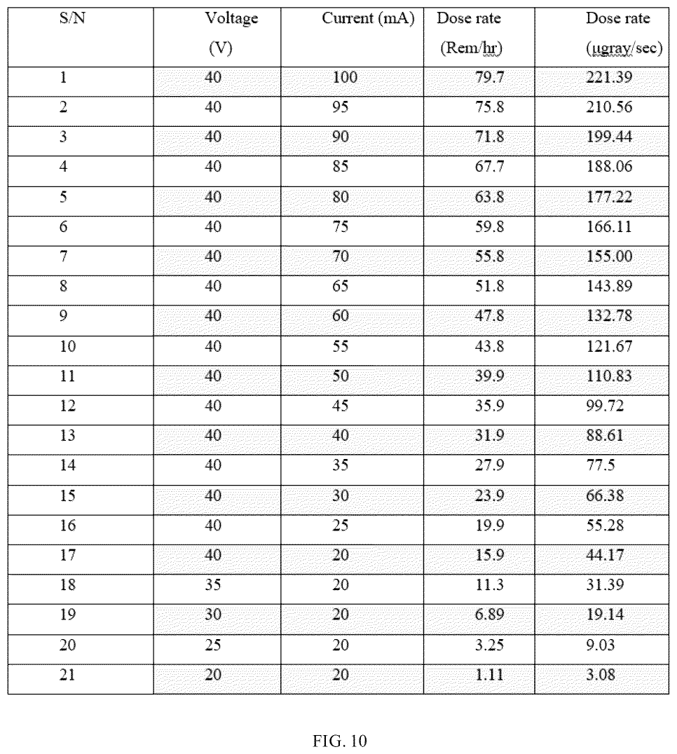

Radioluminescence Spectrum: The RL spectra were acquired using an Edinburgh FS5 spectrofluorometer (Edinburgh Instruments) equipped with an X-ray source (Moxtek Mini-X tube with a W target and 4 W maximum power output; see the table in FIG. 10 for voltage, current, X-ray dose relationship). The X-ray response intensity was examined and collected by a Hamamatsu R928 PMT. The scintillator light yield was estimated using equation (4). The LuAG:Ce (10×10×5 mm, weighing 3.558 g) was used as the reference with a known light yield of 25,000 photons/MeV. A stack of (TPA-P)₂ZnBr₄ crystals forming dimension 10×20×5 mm and weighing about 0.834 g was used to determine the light yield. The spectra of TPA-PBr and (TPA-P)₂ZnBr₄ are similar to that of LuAG:Ce after correcting the intensity and wavelength from the correction files of R928 PMT. Then, the light yield was estimated by comparing the corrected response amplitude (R) of the two samples using equation (4).

$$\frac{Light Yield {( LY )}_{sample}}{Light Yield {( LY )}_{reference}} = \frac{{R}_{sample}}{{R}_{reference}} \times \frac{\frac{\int {I}_{reference} ( λ ) S ( λ )}{\int {I}_{reference} ( λ ) d λ}}{\frac{\int {I}_{sample} ( λ ) S ( λ )}{\int {I}_{reference} ( λ ) d λ}} \qquad ( 4 )$$

The radiation dose rate of the X-ray source was calibrated by using RaySafe 452 dosimeter.

In order to determine the limit of detection (LOD), the background signals were recorded without the sample under X-ray irradiation. Then, a series of signal responses was taken with the sample by irradiating at X-ray dose rate in increasing order, and the slope was determined. The LOD was calculated using equation (5), where Bk_{std} is the standard deviation of background response (see also, Wang et al., Organic phosphors with bright triplet excitons for efficient X-ray-excited luminescence, Nature Photonics 15, 187-192, 2021; which is hereby incorporated by reference herein in its entirety).

$$LOD = \frac{3 * {Bk}_{std}}{Slope} \qquad ( 5 )$$

X-ray imaging: The X-ray imaging system was built as shown in FIG. 5c. The X-ray source used in the imaging was a Moxtek Mini-X tube with a W target and 4 W maximum power output. The dose rate used was 221.39 μGyₐᵢᵣ/s. In this built imaging system, an X-ray beam passed vertically through the object of interest, and the scintillator film, right below it.

The optical path of resulting radioluminescence was then deflected towards the camera by a reflector angled at the imaging system to remove the negative effect caused by direct X-ray irradiation of the camera. An iPhone 13 Pro Max camera was used to capture the deflected image. The images were then converted to black and white.

It is noted that single-crystal X-ray crystallographic data have been deposited at the Cambridge Crystallographic Data Centre (CCDC), under deposition number 2181766 (TPA-PBr) and 2181767 (TPA-P)₂ZnBr₄.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A scintillation material, comprising:
an organic-inorganic hybrid material comprising a metal halide anion and an organic cation,
wherein the scintillation material has a light yield of at least 15,000 photons per mega electron Volt (photons/MeV), and
wherein the scintillation material has a decay lifetime in a range of from 1 nanoseconds (ns) to 100 ns.

2. The scintillation material according to claim 1, wherein the scintillation material has a light yield to decay time ratio of at least 1,000 photons/MeV-ns, and
wherein the scintillation material has a detection limit of no more than 25 nanoGrays per second (nGyₐᵢᵣ/s).

3. The scintillation material according to claim 1, wherein the organic-inorganic hybrid material is a zero-dimensional (0D) material.

4. The scintillation material according to claim 1, wherein the metal halide anion is an X-ray sensitizer and the organic cation is a light emitter.

5. The scintillation material according to claim 1, wherein the organic cation is an aggregate induced emission (AIE) organic cation.

6. The scintillation material according to claim 1, wherein the organic cation is TPA-P⁺.

7. The scintillation material according to claim 1, wherein the metal halide anion is ZnX₄, where X is a halogen.

8. The scintillation material according to claim 1, wherein the organic-inorganic hybrid material is 4-(4-(diphenylamino) phenyl)-1-(Propyl)-pyrindin-lium zinc halide ((TPA-P)₂ZnX₄), where X is a halogen.

9. A detector for X-rays and/or gamma rays, the detector comprising the scintillation material according to claim 1.

10. A method of fabricating a scintillation material, the method comprising:
contacting (i) a triaryl amine substituted with a first electron withdrawing group, and (ii) a pyridine substituted with a second electron withdrawing group, to form an intermediate product;
contacting the intermediate product and an alkyl halide to form an organic halide salt;
providing a precursor liquid in which the organic halide salt and a metal halide salt are disposed; and
contacting the precursor liquid with an antisolvent to form an organic-inorganic hybrid material that is the scintillation material.

11. The method according to claim 11, wherein the first electron withdrawing group is a halide, and
wherein the second electron withdrawing group is —B(OH)₂.

12. The method according to claim 11, wherein the triaryl amine substituted with a first electron withdrawing group is the following compound:

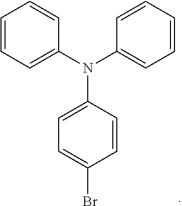 [SMILES: Brc1ccc(N(c2ccccc2)c2ccccc2)cc1]

13. The method according to claim 11, wherein the first electron withdrawing group and the second electron withdrawing group are different from each other.

14. The method according to claim 11, wherein the pyridine substituted with a second electron withdrawing group is the following compound:

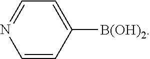

15. The method according to claim 11, wherein the alkyl halide is propyl bromide.

16. The method according to claim 11, wherein the organic halide salt is TBA-PBr,
wherein the antisolvent is diethyl ether, and
wherein the metal halide salt is ZnBr₂ₚₐ.

17. The method according to claim 11, wherein a mole ratio of the organic halide salt to the metal halide salt is in a range of from 0.5:1 to 3.5:1.

18. The method according to claim 11, wherein the organic-inorganic hybrid material is a zero-dimensional (0D) material.

19. The method according to claim 11, wherein the organic-inorganic hybrid material is 4-(4-(diphenylamino) phenyl)-1-(Propyl)-pyrindin-lium zinc bromide ((TPA-P)₂ZnBr₄).

20. The method according to claim 11, wherein the organic-inorganic hybrid material has:
a light yield of at least 15,000 photons per mega electron Volt (photons/MeV);
a decay lifetime in a range of from 1 nanoseconds (ns) to 100 ns;
a light yield to decay time ratio of at least 1,000 photons/MeV-ns; and
a detection limit of no more than 25 nanoGrays per second (nGyₐᵢᵣ/s).photons/MeV.
